(19) United States
(12) Patent Application Publication
(10) Pub. No.: US 2026/0244758 A1
(43) Pub. Date: Aug. 20, 2026

(54) DEVICE AND METHOD FOR UPDATING SOFTWARE

(71) Applicant: ASTEMO, LTD., Tokyo (JP)

(72) Inventors: Nobuyoshi MORITA, Tokyo (JP); Hiroki YAMAZAKI, Tokyo (JP)

(73) Assignee: ASTEMO, LTD., Tokyo (JP)

(21) Appl. No.: 19/159,868

(22) PCT Filed: Apr. 8, 2024
(86) PCT No.: PCT/JP2024/014253

§ 371 Date: Aug. 26, 2025

(30) Foreign Application Priority Data
May 1, 2023 (JP) 2023-075766

(51) Int. Cl. G06F 21/57; G06F 21/55

(52) U.S. Cl. CPC G06F 21/577; G06F 21/554

(57) ABSTRACT

A software update device includes: a risk management unit configured to manage vulnerability information of a target device and a risk tolerance condition in the vulnerability information; and a software update control unit configured to prohibit a software update when it is determined that an update content does not satisfy the tolerance condition in a case where the software update is performed on the target device.

### TECHNICAL FIELD

The present invention relates to a software update device and method for managing a software update of a target device.

### BACKGROUND ART

In recent years, there has been an increasing demand for ensuring safety in cyber security for electric control units (ECUs) installed in vehicles and the like due to improvements in autonomous driving technologies and the rise of communication technologies such as over the air (OTA).

In particular, if any vulnerability is discovered in a product, there is a risk that tens of thousands of vehicles are affected by a cyberattack targeting the vulnerability, and it is necessary to respond to the risk quickly.

An organization called a product security incident response team (PSIRT) is established in an original equipment manufacturer (OEM) of a vehicle. The PSIRT acquires public vulnerability information and industry vulnerability information from each industry association, and investigates whether a supplier has a product corresponding to the acquired vulnerability in cooperation with each department in the OEM.

When there is a product corresponding to the vulnerability, the PSIRT conducts various evaluation tests such as risk assessments and reproduction tests to investigate the degree of influence of the vulnerability. Then, when it is determined that the degree of influence is very large, feedback is provided to a development project to update the product specifications. Lastly, in order to cope with products already on the market, software is reprogrammed, for example, using OTA, and the shipped products are modified.

However, the above-described processing is very difficult in reality, and even if a vulnerability is discovered after product shipment, it is not easy to perform a software update for overcoming the vulnerability. This is because it takes several months to investigate the influence of the software change.

In addition, although the above-described demand for improving safety in cyber security is based on the enforcement of related laws and regulations, the laws and regulations do not require the immediate removal of the discovered vulnerability, and require explanation based on results of assessing risks caused by the vulnerability.

On the other hand, vehicles are usually assumed to be operated for a long period of nearly 20 years, and it is also assumed that a condition under which a risk is initially determined to be tolerable when a vulnerability is discovered may deviate from a risk tolerable range in subsequent operation.

A technique for managing such a risk is disclosed in Patent Literature 1. Patent Literature 1 describes an invention related to a threat information analysis server including a risk level update unit that associates threat information with a risk level of an IoT device based on update information and updates the associated threat information, and an output unit that outputs the associated threat information managed by an associated threat information management unit.

### CITATION LIST

### Patent Literature

Patent Literature 1: WO 2020/080222 A1

### SUMMARY OF INVENTION

### Technical Problem

However, even if the technique described in Patent Literature 1 is used, it is not possible to make a determination corresponding to the risk tolerable range that changes with the lapse of time as described above.

The present invention has been made in view of the aforementioned problem, and an object of the present invention is to provide a software update device capable of determining whether an update content is within a risk tolerable range when software is updated in a target device mounted on a vehicle or the like.

Additional features related to the present invention will become apparent from the description of the present specification and the accompanying drawings. Problems, configurations, and effects other than those described above will become apparent from the following description of embodiments.

### Solution to Problem

In order to solve the aforementioned problem, a software update device according to an embodiment of the present invention includes: a risk management unit configured to manage vulnerability information of a target device and a risk tolerance condition in the vulnerability information; and a software update control unit configured to prohibit a software update when it is determined that an update content does not satisfy the tolerance condition in a case where the software update is performed on the target device.

### Advantageous Effects of Invention

According to the present invention, it is possible to determine whether an update content is within a risk tolerable range when software is updated in a target device mounted on a vehicle or the like.

Additional features related to the present invention will become apparent from the description of the present specification and the accompanying drawings. Problems, configurations, and effects other than those described above will become apparent from the following description of embodiments.

### BRIEF DESCRIPTION OF DRAWINGS

FIG. 1 is a block diagram illustrating a functional configuration and a relationship with an external organization of a software update device according to an embodiment of the present invention.

FIG. 2 is a diagram for explaining processing (event) assumed after a vulnerability is discovered.

FIG. 3 is a flowchart illustrating processing executed when software is updated.

FIG. 4 is a diagram illustrating processing of updating risk management information after a vulnerability is discovered.

FIG. 5 is a diagram for explaining an update content of risk management information.

FIG. 6 is a diagram illustrating processing of updating software.

FIG. 7 is a diagram illustrating a risk tolerance condition referred to when software is updated.

FIG. 8 is a flowchart illustrating processing of verifying a risk tolerance condition executed when software is updated.

FIG. 9 is a diagram illustrating processing of applying a vulnerability correction patch.

FIG. 10 is a diagram illustrating an application content of a vulnerability correction patch.

FIG. 11 is a diagram for explaining an update content of risk management information.

FIG. 12 is a block diagram illustrating a functional configuration and a relationship with an external organization of a software update device according to a modification of the present invention.

### DESCRIPTION OF EMBODIMENTS

Hereinafter, embodiments of the present invention will be described in detail with reference to the drawings.

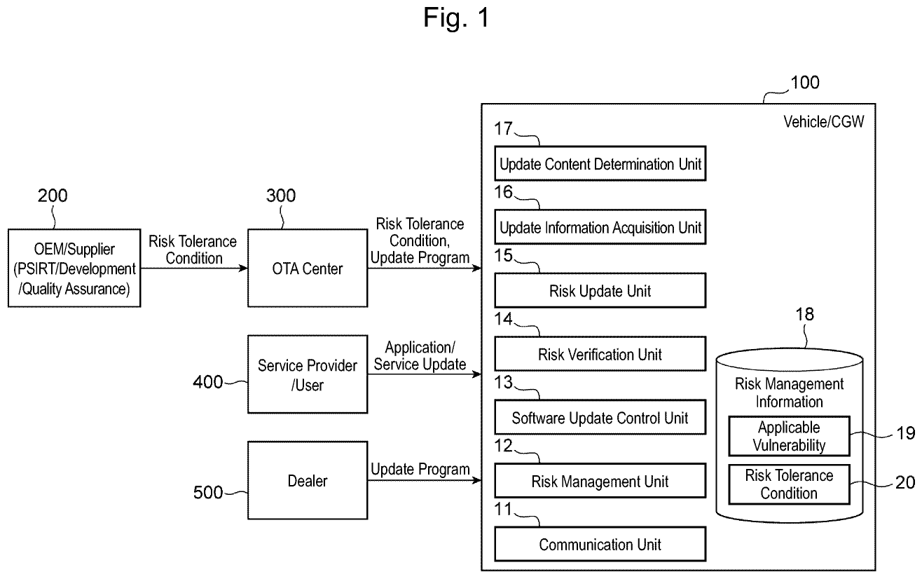

FIG. 1 is a block diagram illustrating a functional configuration and a relationship with an external organization of a software update device according to an embodiment of the present invention. The software update device according to the present embodiment is implemented as a central gate way (CGW) 100 that is a device in a vehicle.

The software update device 100 according to the present embodiment includes, as functional units thereof, a communication unit 11, a risk management unit 12, a software update control unit 13, a risk verification unit 14, a risk update unit 15, an update information acquisition unit 16, and an update content determination unit 17, and includes risk management information 18 as a storage unit. The risk management information 18 includes an applicable vulnerability 19 and a risk tolerance condition 20.

In addition, the software update device 100 receives a risk tolerance condition and an update program from an OEM/supplier 200 via an OTA center 300, receives an application/service update from a service provider/user 400, and receives an update program from a dealer 500.

The software update device 100 includes a CPU (not illustrated), a ROM (not illustrated), and a RAM (not illustrated), and realizes the following functions by the CPU developing programs stored in the ROM in the RAM and executing the programs.

The communication unit 11 transmits and receives information to and from the external organization. The risk management unit 12 manages vulnerability information and a risk tolerance condition in the vulnerability information. The software update control unit 13 controls software update. The risk verification unit 14 verifies whether the software update satisfies the risk tolerance condition. The risk update unit 15 updates the risk tolerance condition based on information for updating the tolerance condition. The update information acquisition unit 16 acquires an update program via the communication unit 11. The update content determination unit 17 determines whether to update the tolerance condition or update the software when a request for software update is received. The applicable vulnerability 19 and the risk tolerance condition 20 included in the risk management information 18 will be described later.

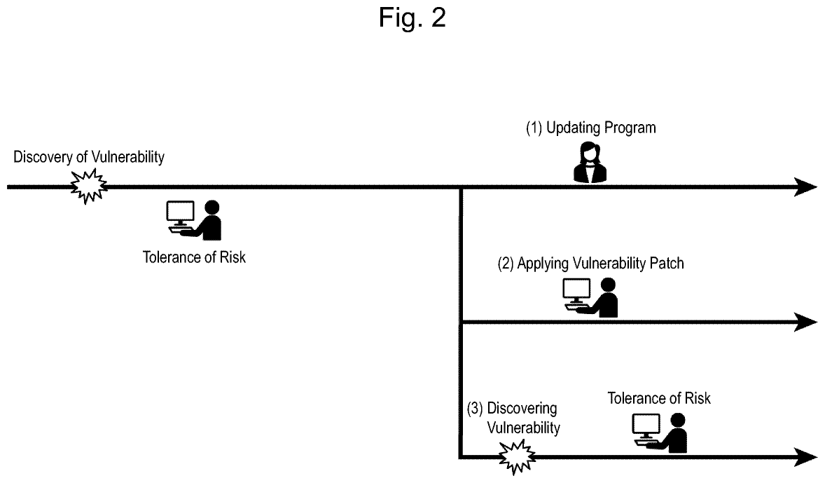

FIG. 2 is a diagram for explaining some patterns that may occur after a vulnerability is discovered in a product. Note that the present invention is based on the premise that a risk of a vulnerability discovered in a product is tolerated at least once.

Once a vulnerability is found and its risk is tolerated, there are three subsequent developments: (1) updating the program, (2) applying a vulnerability patch, and (3) discovering a new vulnerability.

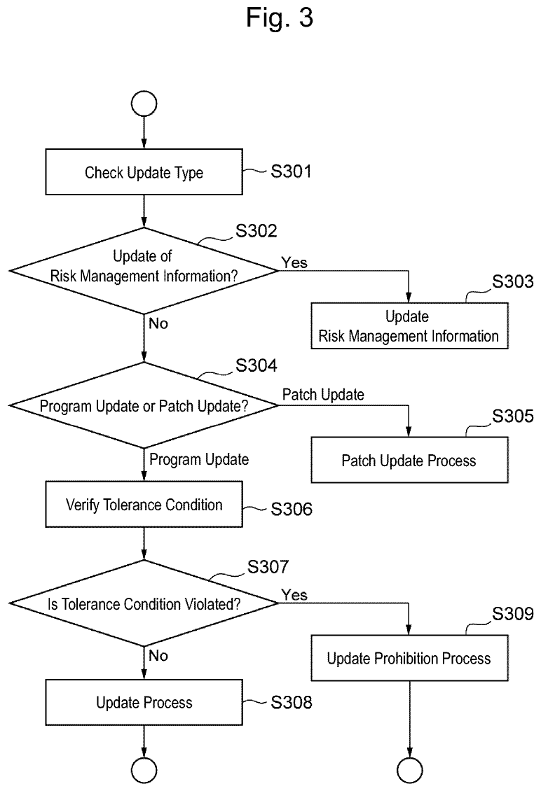

A flowchart for explaining the above developments is illustrated in FIG. 3. After the tolerance of the risk of the discovered vulnerability is determined, when the software update device receives a certain program, the software update control unit 13 checks the update type (step S301). Here, it is determined whether the program is an update of a risk management information (step S302), and when the program is an update of the risk management information, the update is executed (step S303).

When the program is not the update of the risk management information, next, it is determined whether the program relates to a program update or a vulnerability patch update (step S304). A case in which the program relates to a program update corresponds to the above-described stage (1), and the processing proceeds to program update/update prohibition processes in steps S306 to S309. A case in which the program relates to patch update processing corresponds to the stage (2), and the processing proceeds to a patch update process in step S305. These processes will be described in detail later. Then, a case where a vulnerability is newly discovered after these processes corresponds to the above-described stage (3).

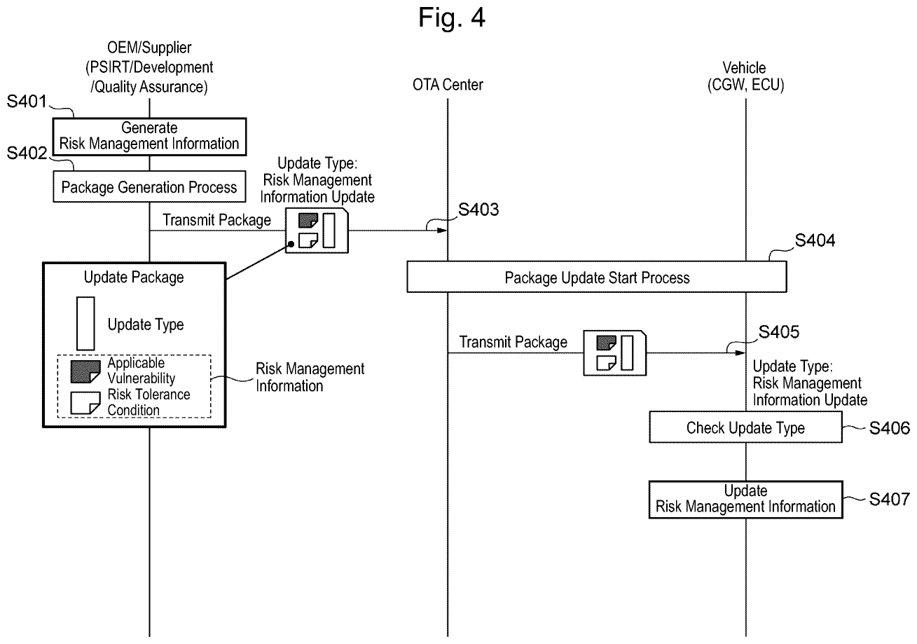

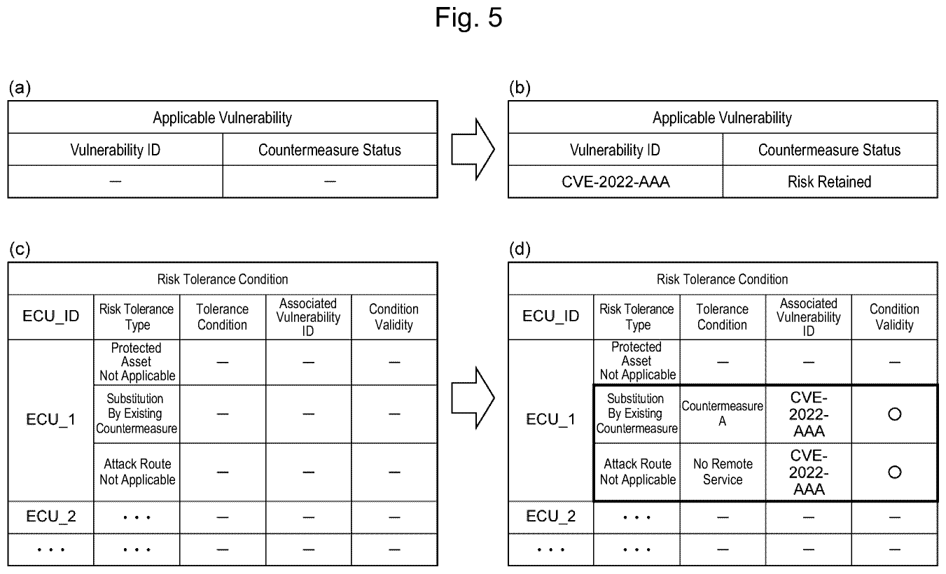

A process executed after a vulnerability is first discovered and it is determined to tolerate a risk will be described with reference to FIGS. 4 and 5. FIG. 4 is a chart diagram illustrating the risk management information update process, and FIG. 5 is a diagram for explaining the update content.

First, the OEM/supplier that has determined to tolerate a risk generates new risk management information (step S401), and performs an update package generation process (step S402). The update package is a collection of an update type, an applicable vulnerability, and a risk tolerance condition. The update type is an identifier indicating the type of update content. The update content includes, for example, a risk management information update, a program update, a vulnerability patch update, and the like.

The generated package is transmitted to the OTA center (step S403), and is further transmitted to the software update device of the vehicle, and at the same time, a package update process is started (steps S404 and S405). The software update device checks the software update type included in the package (step S406), and updates the own risk management information 18 (step S407).

A specific example of the updated risk management information will be described with reference to FIG. 5. As illustrated in FIG. 5, the risk management information includes an applicable vulnerability and a risk tolerance condition. Here, as illustrated in FIGS. 5(a) and 5(c), it is assumed that no information is registered for the applicable vulnerability and the risk tolerance condition before the update.

Then, it is assumed that the received package includes information “vulnerability ID: CVE-2022-AAA, countermeasure status: risk retained” as illustrated in FIG. 5(b). That is, this means that, although the vulnerability identified by the aforementioned ID has been discovered this time, it is determined that the risk caused by this vulnerability is tolerable (even if the risk is left, it does not become a threat).

In this case, the package includes information as illustrated in FIG. 5(d) as the risk tolerance condition. This means that “substitution by existing countermeasure” as a risk tolerance type and “countermeasure A” as a tolerance condition have already been implemented in the product, and the risk of vulnerability discovered this time can be tolerated by this countermeasure. In addition, “attack route not applicable” as a risk tolerance type and “no remote service” as a tolerance condition mean that no remote (wireless) access route exists in the product, that is, there is no concern that the product will be targeted by an attacker, and thus, the risk can be tolerated.

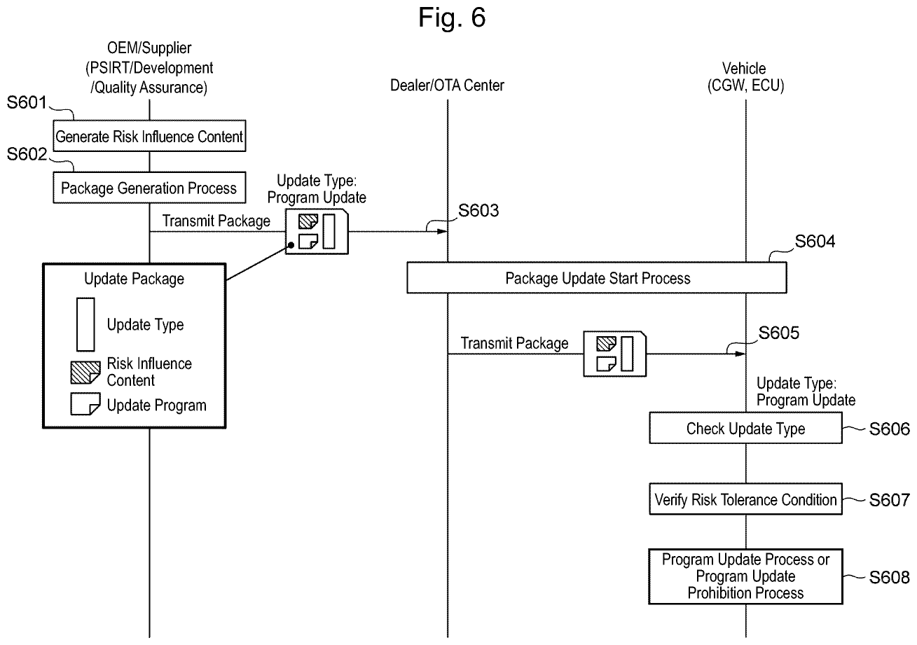

Next, processing in a case where a program update is executed after the first determination to tolerate the risk described above, that is, at the stage (1) of FIG. 2, will be described with reference to FIGS. 6 to 8.

As illustrated in FIG. 6, first, the OEM/supplier generates a risk influence content related to the vulnerability of which the risk is tolerated (step S601), and generates a package (step S602). The package includes an update type, a risk influence content, and an update program.

The generated package is transmitted to the dealer/OTA center (step S603), is also transmitted to the software update device of the vehicle, and at the same time, a package update process is started (steps S604 and 605).

The software update device that has received the package unpacks the package and checks the update type (step S606). This step corresponds to step S304 in the flowchart illustrated in FIG. 3. Here, it is assumed that the update type is not a patch update but a program update. That is, the processing proceeds to step S306 in the flowchart illustrated in FIG. 3.

Then, the software update device verifies the risk tolerance condition (step S607). This step corresponds to step S306 in the flowchart of FIG. 3. Then, a program update/update prohibition process is performed according to the verified content (step S608).

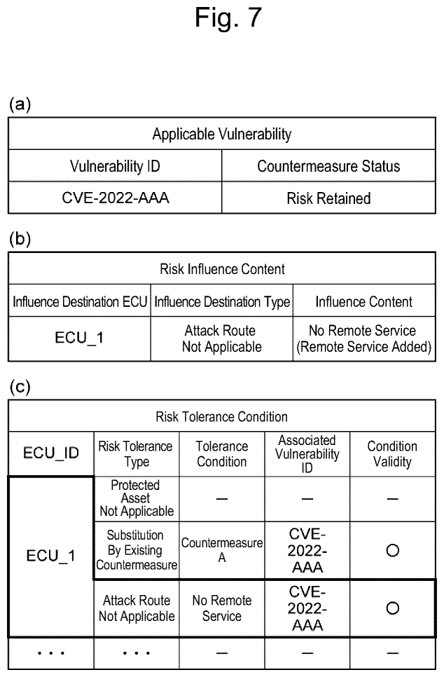

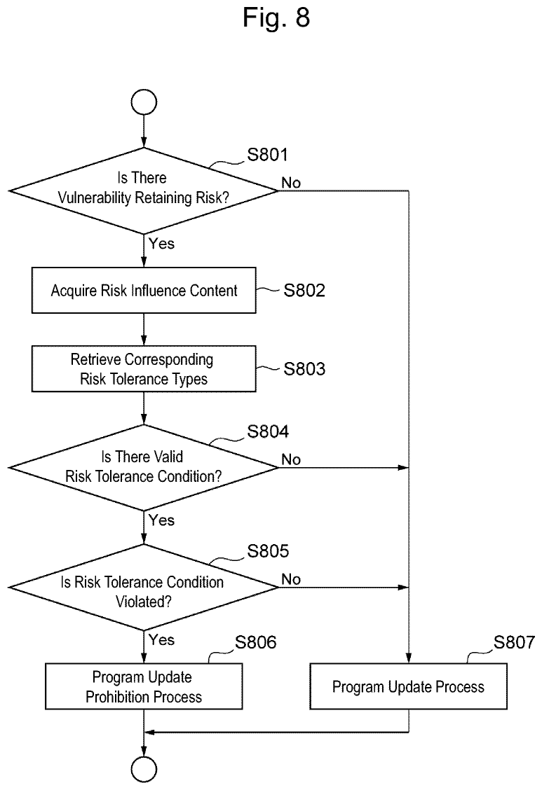

The verification of the risk tolerance condition described above will be described with reference to FIGS. 7 and 8. In order to verify the risk tolerance condition, it is necessary to consider the risk influence content illustrated in FIG. 7(b) in addition to the applicable vulnerability and the risk tolerance condition illustrated in FIGS. 7(a) and 7(c), which have already been described above.

The risk influence content indicates a range and content of influence when the update program included in the package is executed. In the present embodiment, the execution of the update program influences an in-vehicle device ECU_1, and “influence destination type: attack route not applicable” and “influence content: no remote service (remote service added)” are registered as the influence content. This means that, when this update program is executed, a remote service that can access the in-vehicle device ECU_1 is added.

Here, the risk tolerance condition of FIG. 7(c) is referred to. Before the program update, the risk of the vulnerability in ECU_1 identified by vulnerability ID: CVE-2022-AAA was tolerated because the tolerance condition: no remote service was valid. However, when the risk influence content described above is taken into consideration, a remote service that can access ECU_1 is added, and the validity of the condition is lost. Therefore, a process of prohibiting a program update having such an influence is performed. If the validity of the condition is not lost, the program update may be executed.

The above processing will be described with reference to a flowchart of FIG. 8. First, the software update device checks the content of the received package, and determines whether there is a vulnerability retaining a risk (step S801). Here, when it is determined that there is no vulnerability retaining a risk, this means that it is not required to consider risk tolerance, and thus, a program update process is executed (step S807).

When there is a vulnerability that needs to retain a risk, the processing proceeds to step S802, and a risk influence content as illustrated in FIG. 7(b) is acquired. Then, corresponding risk tolerance types are retrieved from the risk management information (step S803). Next, it is determined whether there is a valid risk tolerance condition among the retrieved risk tolerance types (step S804). When there is no valid risk tolerance condition, this means that there is no risk tolerance condition that becomes invalid by the program update, and thus a program update process is executed (step S807).

When there is a valid risk tolerance condition, it is determined whether the risk tolerance condition is violated by the program update (step S805). When the risk tolerance condition is not violated by the program update, the risk tolerance condition remains satisfied even though the program is updated, and thus, a program update is executed (step S807). When the risk tolerance condition is violated by the program update, a process of prohibiting the program update is executed (step S806). The processing of verifying the risk tolerance condition has been described above, and corresponds to steps S306 to S309 of the entire processing described in FIG. 3.

Note that, regarding the process of prohibiting the program update described above, there may be a case where further detailed analysis is performed on the software that is prohibited from being updated, and as a result, it is determined that the risk tolerance condition has not been violated. In such a case, the program update using the software may be executed.

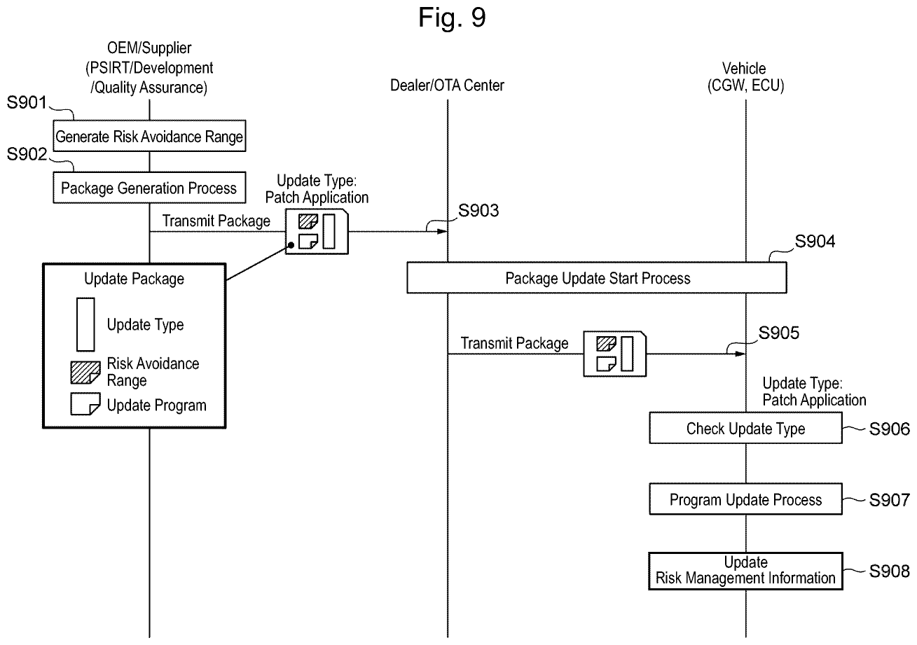

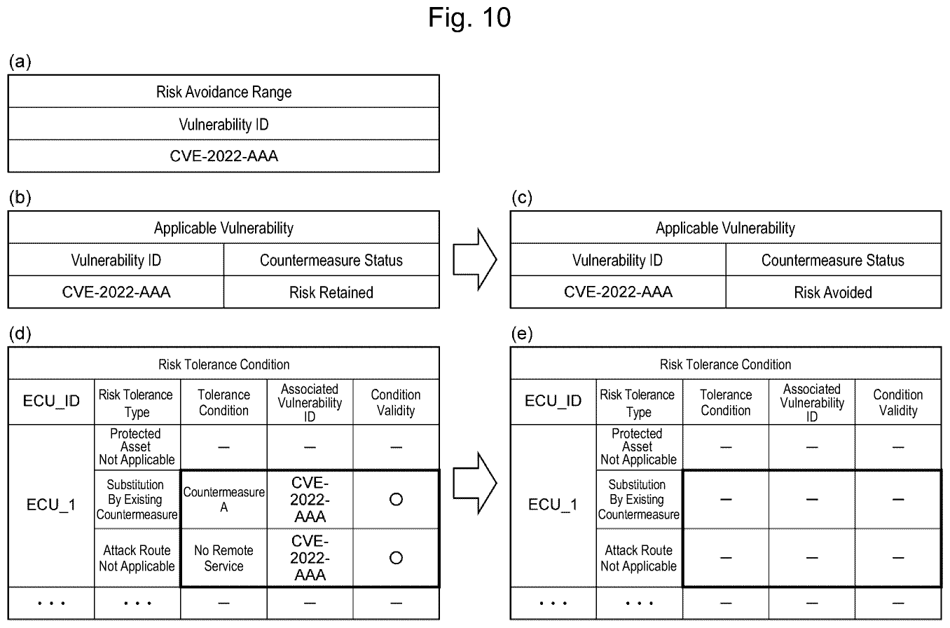

Next, a case where a vulnerability patch is applied after it is first determined to tolerate the risk, that is, the case (2) in FIG. 2, will be described with reference to FIGS. 9 and 10.

When applying a vulnerability patch, the OEM/supplier generates a risk avoidance range (step S901). The risk avoidance range indicates a range of a vulnerability that can be avoided by applying the patch. Then, a package including the risk avoidance range is generated (step S902).

The generated package is transmitted to the dealer/OTA center (step S903), and is further transmitted to the software update device of the vehicle, and at the same time, a package update process is started (steps S904 and S905).

The software update device unpacks the received package and checks the update type (step S906). In this case, since the update type is patch application and there is no influence on the risk tolerance condition, a program update process is executed as is (step S907). Lastly, the risk management information changed by the patch application is updated, and the processing ends (step S908).

FIG. 10 illustrates the risk avoidance range and the changed risk management information. In the present embodiment, the risk avoidance range was a vulnerability identified by vulnerability ID: CVE-2022-AAA as illustrated in FIG. 10(a). Then, since the risk related to this vulnerability is eliminated by applying the patch to this vulnerability, the applicable vulnerability becomes “risk avoided” as illustrated in FIGS. 10(b) and 10(c), and the risk tolerance condition is also reset.

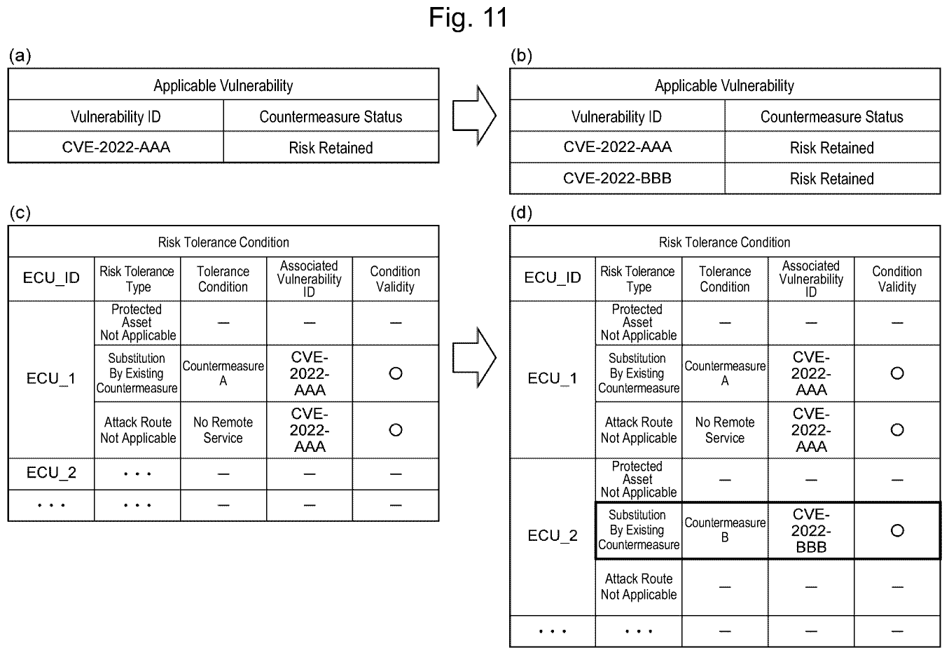

Lastly, a case where a vulnerability is newly discovered after it is first determined to tolerate the risk, that is, the case (3) in FIG. 2, will be described with reference to FIG. 11.

In a case where a vulnerability is newly discovered, the applicable vulnerability and the risk tolerance condition of the risk management information are updated as illustrated in FIG. 11. In the present embodiment, a vulnerability identified by vulnerability ID: CVE-2022-BBB is newly found as an applicable vulnerability as illustrated in FIG. 11(b), and it can be seen that, as a tolerance condition in an in-vehicle device ECU_2, the risk tolerance type is “substitution by existing countermeasure”, and the tolerance condition is “countermeasure B” as illustrated in FIG. 11(d).

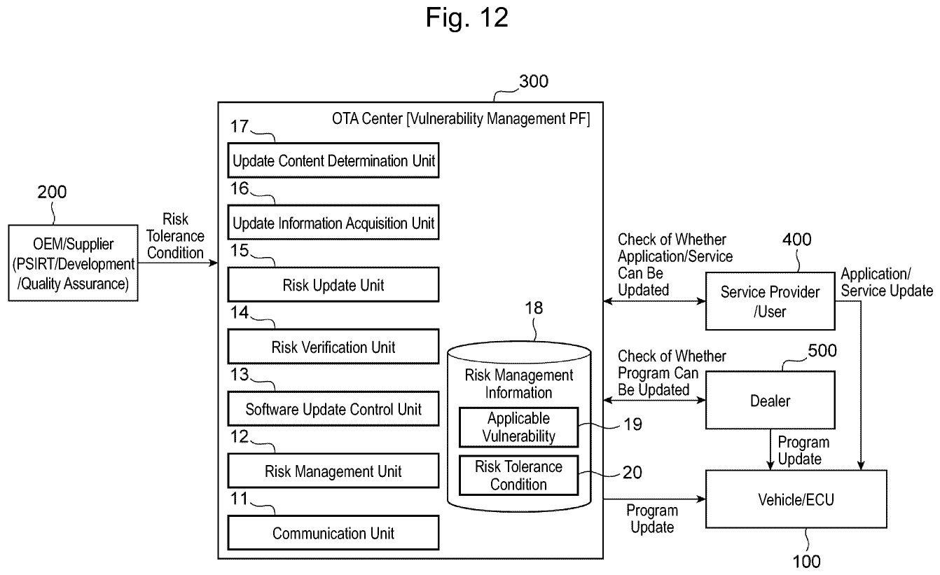

It has been described above that the software update device is mounted on the vehicle. However, as a modification of the present invention, as illustrated in FIG. 12, it is also possible to provide a function as a software update device to the OTA center 300 communicably connected to the vehicle/ECU.

According to the present embodiment, processing can be performed collectively by the OTA center connected to a large number of vehicles/ECUs, thereby unifying the processing.

According to the embodiment of the present invention described above, the following advantageous effects are obtained.

(1) A software update device according to an embodiment of the present invention includes: a risk management unit configured to manage vulnerability information of a target device and a risk tolerance condition in the vulnerability information; and a software update control unit configured to prohibit a software update when it is determined that an update content does not satisfy the tolerance condition in a case where the software update is performed on the target device.

With the above configuration, when the software of the target device mounted on the vehicle or the like is updated, it is possible to determine whether the update content is within the risk tolerable range, thereby preventing a program update that may endanger the security of the vehicle.

(2) The software update device further includes a risk verification unit configured to verify whether the update content satisfies the tolerance condition when the software update is performed. The function of the risk verification unit enables comparison between the update content in (1) and the tolerance condition.

(3) The software update device further includes a risk update unit configured to update the tolerance condition based on information for updating the tolerance condition. Since the risk tolerance condition relates to whether the software can be updated, it is necessary to always keep the risk tolerance condition up to date, and such a risk update unit is useful.

(4) The software update device further includes an update information acquisition unit configured to acquire the information for updating the tolerance condition and an update program used for the software update, and an update content determination unit configured to determine whether to perform the tolerance condition update or the software update. Since the priority order between the tolerance condition update and the software update varies depending on the content thereof, it is possible to select an appropriate process by adopting such a configuration.

(5) A software update method according to an embodiment of the present invention corresponds to the software update device according to (1), and has the same effect as (1).

Note that the present invention is not limited to the above embodiments, and various modifications can be made. For example, the above embodiments have been described in detail to describe the present invention in an easy-to-understand manner, and the present invention is not necessarily limited to an aspect including all the described configurations. In addition, a part of a configuration of one embodiment can be replaced with a configuration of another embodiment. In addition, a configuration of one embodiment can be added to a configuration of another embodiment. In addition, a part of a configuration of each embodiment can be deleted, or added to or replaced with another configuration.

### REFERENCE SIGNS LIST

12 Risk management unit
13 Software update control unit
14 Risk verification unit
15 Risk update unit
16 Update information acquisition unit
17 Update content determination unit
100 Software update device

1. A software update device comprising:
a risk management unit configured to manage vulnerability information of a target device and a risk tolerance condition in the vulnerability information; and
a software update control unit configured to prohibit a software update when it is determined that an update content does not satisfy the tolerance condition in a case where the software update is performed on the target device.

2. The software update device according to claim 1, further comprising a risk verification unit configured to verify whether the update content satisfies the tolerance condition when the software update is performed.

3. The software update device according to claim 1, further comprising a risk update unit configured to update the tolerance condition based on information for updating the tolerance condition.

4. The software update device according to claim 3, further comprising:
an update information acquisition unit configured to acquire the information for updating the tolerance condition and an update program used for the software update; and
an update content determination unit configured to determine whether to perform the tolerance condition update or the software update.

5. A software update method comprising:
acquiring vulnerability information of a target device and a risk tolerance condition in the vulnerability information; and
prohibiting a software update when it is determined that an update content does not satisfy the tolerance condition in a case where the software update is performed on the target device.
